(19) United States
(12) Patent Application Publication
(10) Pub. No.: US 2013/0153232 A1
(43) Pub. Date: Jun. 20, 2013

(54) METHODS AND COMPOSITIONS FOR REDUCING PERMEABILITY OF A SUBTERRANEAN FORMATION

(71) Applicant: Calfrac Well Services Ltd., Calgary (CA)

(72) Inventors: Dwight Bobier, Calgary (CA); Ronald Pierce, Vancouver (CA)

(73) Assignee: CALFRAC WELL SERVICES LTD., Calgary (CA)

(21) Appl. No.: 13/710,959

(22) Filed: Dec. 11, 2012

(30) Foreign Application Priority Data
Dec. 15, 2011 (CA) 2762502

(51) Int. Cl. E21B 43/12; C09K 8/06

(52) U.S. Cl. CPC E21B 43/12; C09K 8/06
USPC 166/305.1; 507/136; 507/104; 507/117

(57) ABSTRACT

The present application is directed to an aqueous composition made up of an alkali metal silicate; a hardener containing at least one dibasic ester, at least one nonionic surfactant, at least one terpene or terpene derivative and optionally at least one polyalkylene glycol; and a retarder. The composition is useful for reducing the permeability in a subterranean formation, so as to reduce or prevent water flow and circulation loss of well fluids such as drilling fluids or cement.

### BACKGROUND

The present application relates to methods and compositions for reducing the permeability of subterranean wells so as to prevent water production and lost circulation during oil and hydrocarbon recovery. More specifically, the present application relates to compositions comprising an alkali metal silicate and a dibasic ester hardener, and methods of using this composition to block pores and cracks in subterranean wells.

Water production is a major problem in the oil industry. Underground formations producing oil, natural gas or other hydrocarbons often also contain water, which may be brought to the surface along with, or in place of, the desired hydrocarbon. In addition, water can be a byproduct of an enhanced recovery technique whereby water is injected into a petroleum reservoir to displace oil which is not otherwise economically recoverable. Water production reduces the rate of hydrocarbon production from a formation, and the water byproduct, which can contain inorganic or organic components that may be toxic or pose environmental risks, must be disposed of at additional cost.

One approach to managing the undesired production of water from hydrocarbon-producing formations is to use water shutoff compositions, which are injected into the formation and block water flow while allowing the hydrocarbon to enter the well bore. Such water shutoff products include polymer gels or gallants such as cross-linked polyacrylamides or polysaccharides such as xanthan, which selectively enter, and set up in, the cracks and pathways through which water would enter the bore, thereby blocking water flow. Silica gels formed by reaction of an alkali metal silicate with reagents such as calcium chloride, acid-forming compounds, aldehydes, or ammonium or aluminum salts, have also been used to prevent water production, as described, for example, in U.S. Pat. Nos. 1,421,706 and 4,004,639. However, while such silica gels act to plug cracks in the formation, they do not bind strongly to the formation, US Published Application No. 2004/0031611 also describes a water shutoff composition containing a silica gel formed by allowing an alkali metal silicate to react with a dialkyl ester of a dicarboxylic acid as a hardener in the presence of a catalyst such as an alkali metal hydroxide or tertiary alkanol amine.

Another problem facing the petroleum industry is the lost circulation of drilling muds and other well treatment fluids into cavities, pores or fractures within a subterranean formation. Such fluid loss from the wellbore can cause economic losses and even safety concerns, as the lowered drilling fluid pressure can result in a blowout. Lost circulation has been addressed by adding inert lost circulation materials, cement or gelling agents which plug the spaces in the formation. U.S. Pat. Nos. 4,665,985, 4,799,549, 7,226,895 and 7,703,522 describe the use of mixtures comprising an alkaline silicate solution and an alkyl diester of a dicarboxylic acid for the temporary or permanent sealing of a subterranean formation.

However, produced water and lost circulation continue to be problems for the petroleum industry. Therefore, new methods and compositions for reducing the permeability of subterranean formations, so as to shut off water production in hydrocarbon-producing formations, or prevent the loss of circulation of drilling fluids, cement and other well treatment fluids, are needed.

### SUMMARY

In one aspect, the present application is directed to an aqueous composition for reducing the permeability of a subterranean formation by formation of a silica gel. The composition comprises an alkali metal silicate; a hardener comprising at least one dibasic ester, at least one non-ionic surfactant, at least one terpene or terpene derivative and optionally at least one polyalkylene glycol; and a retarder.

Another aspect of the present application is directed to the use of a composition as described herein for reducing or preventing water flow in a subterranean formation, including but not limited to a hydrocarbon-producing formation.

Yet another aspect of the present application is directed to the use of a composition as described herein for reducing or preventing lost circulation in a subterranean formation, including but not limited to a hydrocarbon-producing formation.

### BRIEF DESCRIPTION OF THE DRAWINGS

Further features of the present invention will become apparent from the following written description and the accompanying figures, in which:

FIG. 1 is a graph showing the change in relative permeability with time of a core sample after injection of one embodiment of the present aqueous composition.

### DETAILED DESCRIPTION OF THE INVENTION

In at least one embodiment, the present aqueous composition is a clear, non-viscous water-based fluid which is injected into the matrix of a subterranean formation. Under the ambient conditions in the formation, reaction of the components of the composition forms a silicate material which binds to the formation matrix and plugs pores within the formation, thereby preventing passage of water and loss of well treatment fluids through the pores.

The composition comprises an alkali metal silicate; a hardener; a retarder; and water. In at least one embodiment, the composition contains about 25% to about 60% by volume of the alkali metal silicate; about 5% to about 15% by volume of the hardener; about 0.1% to about 1.5% by volume of the retarder; and about 25% to about 60% water by volume. In at least one embodiment, the composition contains about 40% to about 60% by volume of the alkali metal silicate; about 10% to about 15% by volume of the hardener; about 0.1% to about 1.5% by volume of the retarder; and about 30% to about 60% water by volume.

In at least one embodiment, the alkali metal silicate is selected from sodium silicate, potassium silicate and mixtures thereof. In at least one embodiment, the alkali metal silicate is sodium silicate. In at least one embodiment, the alkali metal silicate is provided as an aqueous solution containing 37.5% by weight of sodium silicate. In such embodiments, the composition contains from about 25% to about 60% by volume of the aqueous solution containing 37.5% of sodium silicate by weight, such that the concentration of sodium silicate in the composition ranges from about 9% to about 23% by weight. In at least one embodiment, the alkali metal silicate is provided as N™ sodium silicate solution, a product of The PQ Corporation.

The hardener contains at least one dibasic ester, at least one non-ionic surfactant, at least one terpene or terpene derivative and optionally at least one polyalkylene glycol. In at least one embodiment, the hardener contains about 30% to about 60% by weight of the at least one dibasic ester, about 30% to about 60% by weight of the at least one non-ionic surfactant, about 1% to about 15% by weight of the at least one terpene or terpene derivative and no more than 5% by weight of the at least one polyalkylene glycol.

In at least one embodiment, the at least one dibasic ester has the structural formula:

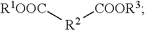

wherein R¹ and R³ are each independently selected from (C₁₋₂₀)alkyl, (C₃₋₁₀)cycloalkyl, aryl, (C₁₋₁₂)alkylaryl and aryl(C₁₋₁₂)alkyl; and R² is —(CH₂)ₚ—, wherein p is an integer from 2 to 7, and wherein the —(CH₂)ₚ— group is optionally substituted with from 1 to 3 (C₁₋₃)alkyl groups.

In at least one embodiment, R¹ and R³ are each independently a (C₁₋₁₂)alkyl group. In at least one embodiment, R¹ and R³ are each independently a (C₁₋₈)alkyl group. In at least one embodiment, R¹ and R³ are each independently a (C₁₋₆)alkyl group. In at least one embodiment, R¹ and R³ are each independently selected from methyl, ethyl, propyl, 1-methylethyl, butyl, 2-methylpropyl, pentyl, 3-methylbutyl, hexyl, cyclohexyl, heptyl, octyl and 2-ethylhexyl. In at least one embodiment, R¹ and R³ are each independently selected from methyl, ethyl, propyl, 1-methylethyl, butyl, 2-methylpropyl, pentyl and 3-methylbutyl. In at least one embodiment, R¹ and R³ are each independently selected from a hydrocarbon group originating from an alcohol found in fusel oil. In at least one embodiment, R² is —(CH₂)ₚ—, wherein p is 2, 3 or 4, and the —(CH₂)ₚ— group is optionally substituted with from 1 to 3 (C₁₋₃)alkyl groups.

In at least one embodiment, the at least one dibasic ester is selected from one or more of a di(C₁₋₈)alkyl succinate, a di(C₁₋₈)alkyl glutarate, a di(C₁₋₈)alkyl adipate, and a mixture thereof, each of which can be further substituted on the succinate, glutarate or adipate portions with from 1 to 3 (C₁₋₃)alkyl groups. In at least one embodiment, the at least one dibasic ester is selected from one or more of a di(C₁₋₆)alkyl ethylsuccinate, a di(C₁₋₆)alkyl methylglutarate, a di(C₁₋₆)alkyl adipate, and a mixture thereof. In at least one embodiment, the at least one dibasic ester is selected from one or more of a dimethyl ethylsuccinate, a diethyl ethylsuccinate, a dimethyl methylglutarate, a diethyl methylglutarate, a dimethyl adipate, a diethyl adipate, and a mixture thereof. In at least one embodiment, the at least one dibasic ester is selected from one or more of dimethyl ethylsuccinate, diethyl ethylsuccinate, dimethyl 2-methylglutarate, diethyl 2-methylglutarate, dimethyl 3-methylglutarate, diethyl 3-methylglutarate, dimethyl adipate, diethyl adipate, and a mixture thereof. In at least one embodiment, the at least one dibasic ester is dimethyl 2-methylglutarate.

The term “substituent”, as used herein and unless specified otherwise, is intended to mean an atom, radical or group which may be bonded to a carbon atom, a heteroatom or any other atom which may form part of a molecule or fragment thereof, which would otherwise be bonded to at least one hydrogen atom. Substituents contemplated in the context of a specific molecule or fragment thereof are those which give rise to chemically stable compounds, such as are recognized by those skilled in the art.

The terms “alkyl” or “(C₁₋ₙ)alkyl” wherein n is an integer, as used herein and unless specified otherwise, either alone or in combination with another radical, are intended to mean an acyclic, straight or branched chain, saturated alkyl radical containing from 1 to n carbon atoms, wherein n is an integer. “Alkyl” includes, but is not limited to, methyl, ethyl, propyl (n-propyl), butyl (n-butyl), 1-methylethyl(iso-propyl), 1-methylpropyl(sec-butyl), 2-methylpropyl(iso-butyl), 1,1-dimethylethyl(tert-butyl), pentyl (n-pentyl), hexyl (n-hexyl), octyl (n-octyl), decyl (n-decyl), isodecyl(8-methylnonyl), dodecyl (n-dodecyl), and tetradecyl (n-tetradecyl).

The terms “cycloalkyl” or “(C₃₋ₘ)cycloalkyl” wherein m is an integer, as used herein and unless specified otherwise, either alone or in combination with another radical, are intended to mean a saturated cycloalkyl substituent containing from 3 to no carbon atoms, wherein m is an integer, and includes, but is not limited to, cyclopropyl, cyclobutyl, cyclopentyl, cyclohexyl and cycloheptyl.

The term “aryl” as used herein and unless specified otherwise, either alone or in combination with another radical, is intended to mean a carbocyclic aromatic monocyclic group containing 6 carbon atoms which may be further fused to one or more 5- or 6-membered carbocyclic groups, each of which may be aromatic, saturated or unsaturated. “Aryl” includes, but is not limited to, phenyl, indanyl, indenyl, 1-naphthyl, 2-naphthyl, tetrahydronaphthyl and dihydronaphthyl.

The terms “arylalkyl” or “aryl(C₁₋ₙ)alkyl” wherein n is an integer, as used herein and unless specified otherwise, either alone or in combination with another radical, are intended to mean a saturated, acyclic alkyl radical having 1 to n carbon atoms as defined above which is itself substituted with an aryl radical as defined above. Examples of arylalkyl include, but are not limited to, phenylmethyl(benzyl), 1-phenylethyl, 2-phenylethyl and phenylpropyl.

The terms “alkylaryl” or “(C₁₋ₙ)alkylaryl” wherein n is an integer, as used herein and unless specified otherwise, either alone or in combination with another radical, are intended to mean an aryl radical as defined above which is itself substituted with one or more saturated, acyclic alkyl radicals each having 1 to n carbon atoms as defined above. Examples of alkylaryl include, but are not limited to, 2-methylphenyl, 3-methylphenyl, 4-methylphenyl, 2-ethylphenyl, 3-ethylphenyl, 4-ethylphenyl, 2,3-dimethylphenyl, and the like.

Methods for the preparation of the at least one dibasic ester of the present hardener are described in U.S. Patent Application Publication 2009/0281012. For example, the at least one dibasic ester of the present hardener can be prepared from one or more dinitrile precursors, by methods well known in the art. In at least one embodiment, the one or more dinitrile precursors can be a mixture of dinitriles formed in the industrial process for the manufacture of adiponitrile by double hydrocyanation of butadiene. Such a mixture of dinitriles includes at least one of adiponitrile, methylglutaronitrile and ethylsuccinonitrile. In addition, the at least one dibasic ester of the present hardener can be prepared from one or more by-products in the reaction, synthesis and/or production of adipic acid used in the production of polyamide, including but not limited to polyamide 6,6.

In at least one embodiment, the at least one non-ionic surfactant is at least one aliphatic alkoxylated alcohol. In at least one embodiment, the at least one aliphatic alkoxylated alcohol is at least one ethoxylated alcohol of the formula:

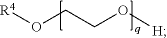

wherein R⁴ is a (C₅₋₂₅)alkyl group which is branched or linear; and q is an integer from 1 to about 30. In at least one embodiment. R⁴ is a (C₆-16)alkyl group which is branched or linear. In at least one embodiment. R⁴ is a (C₈₋₁₃)alkyl group which is branched or linear. In at least one embodiment, q is an integer from about 2 to about 20. In at least one embodiment, q is an integer from about 3 to about 12. In at least one embodiment, the ethoxylated alcohol is an ethoxylated isodecyl alcohol.

In at least one embodiment, the at least one non-ionic surfactant has an HLB number between about 7 and about 15. As is well understood in the art, the term “HLB number” or “Hydrophile-Lipophile Balance number” is a measure of the hydrophobicity or hydrophilicity of a non-ionic surfactant, or its affinity for water or oil. Surfactants with higher HLB numbers (for example, greater than 10) have a relatively greater affinity for water, and are more hydrophilic, while those with lower HLB numbers (for example, less than 10) have a relatively greater affinity for oil and are more lipophilic.

In at least one embodiment, the at least one terpene is selected from pinene and limonene, including stereoisomers, enantiomers and racemates thereof and mixtures thereof. Pinene includes but is not limited to the structural isomers α-pinene and β-pinene, including stereoisomers, enantiomers and racemates thereof and mixtures thereof. In at least one embodiment, the terpene is α-pinene, β-pinene, (+)-limonene or mixtures thereof. In at least one embodiment, the terpene derivative is a terpene alkoxylate having the formula

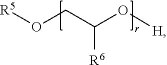

wherein R⁵ is a terpenyl radical. R⁶ is independently in each instance H or a (C₁₋₃)alkyl group, and r is an integer of from about 1 to about 50. In at least one embodiment, R⁵ is a pinenyl radical or a limonenyl radical. In at least one embodiment. R⁵ is an α-pinenyl radical, a 6-pinenyl radical or a (+)-limonenyl radical. In at least one embodiment. R⁶ is independently in each instance H or CH₃. In at least one embodiment, the terpene alkoxylate is an ethoxyl propoxyl terpene.

In at least one embodiment, the hardener further comprises no more than 5% by weight of a polyalkylene glycol. In at least one embodiment, the polyalkylene glycol is selected from polyethylene glycol and polypropylene glycol. In at least one embodiment, the polyalkylene glycol is polyethylene glycol. In at least one embodiment, when the hardener comprises up to 5% by weight of a polyalkylene glycol, the hardener has a reduced tendency to become cloudy.

In at least one embodiment, the hardener comprises about 30% to about 60% by weight of at least one dibasic ester; about 30% to about 60% by weight of at least one aliphatic ethoxylated alcohol; about 1% to about 15% by weight of at least one terpene; and no more than 5% by weight polyethylene glycol. In at least one embodiment, the hardener comprises about 30% to about 60% by weight of ethoxylated isodecyl alcohol; about 30% to about 60% by weight of at least one dibasic ester selected from one or more of a di(C₁₋₆)alkyl ethylsuccinate, a di(C₁₋₆)alkyl methylglutarate, a di(C₁₋₆)alkyl adipate and mixtures thereof; about 1% to about 15% by weight of at least one terpene selected from pinene, (+)-limonene and mixtures thereof; and no more than 5% by weight polyethylene glycol.

In at least one embodiment, the hardener comprises about 30% to about 60% by weight of at least one dibasic ester; about 30% to about 60% by weight of at least one aliphatic ethoxylated alcohol; about 5% to about 10% by weight of at least one ethoxylpropoxyl terpene; and no more than 5% by weight polyethylene glycol. In at least one embodiment, the hardener comprises about 30% to about 60% by weight of ethoxylated isodecyl alcohol; about 30% to about 60% by weight of dimethyl 2-methylglutarate; about 5% to about 10% by weight of at least one ethoxyl propoxyl terpene; and no more than 5% by weight polyethylene glycol. Suitable hardeners include but are not limited to Rhodiasolv™ Infinity (Rhodia). In at least one embodiment, the present hardener has at least one of the properties of being environmentally friendly, biodegradable, non-toxic, or non-flammable. In at least one embodiment, the hardener has a flash point higher than 140° C.

In at least one embodiment, the hardener is a microemulsion additionally comprising no more than 20% water by volume. In at least one embodiment, the hardener is a microemulsion additionally comprising from about 1% to about 20% water by volume. In at least one embodiment, the hardener additionally comprises from about 2% to about 20% water by volume. In at least one embodiment, the hardener additionally comprises from about 12% to about 20% water by volume. In at least one embodiment, the hardener additionally comprises about 12% water by volume.

In at least one embodiment, the retarder is a borate compound. In at least one embodiment, the borate compound is selected from borax, sodium tetraborate, anhydrous borax, borax pentahydrate, borax decahydrate, and boric acid. The person of skill in the art will also be aware of other possible retarders, including but not limited to alkaline earth metal hydroxides and carbonates.

The present aqueous composition is useful to reduce the permeability of a subterranean formation, and can be injected into the formation matrix. In at least one embodiment, the composition has a density and viscosity comparable to that of water, so that it can be readily injected into, and will readily flow within, the formation. In at least one embodiment, the composition has a specific gravity of about 1.15, measured at 20° C. and 1 atmosphere pressure.

The components of the composition react and harden to plug pores in the formation. In this way, flow of water into the wellbore, as well as lost circulation of well treatment fluids through pores in the formation, can be reduced or prevented. In at least one embodiment, the time required for the composition to harden or set up to form a plug is from about 0.5 hours to about 2 hours after injection into the formation. In at least one embodiment, the time required for the composition to harden is about 1 hour after injection into the formation. In at least one embodiment, the time required for the composition to set up does not depend significantly on the temperature within the formation. In at least one embodiment, the time required for the composition to set up can be controlled by changing the ratio of the alkali metal silicate to the hardener.

In at least one embodiment, the composition further comprises a pozzolanic material. In at least one embodiment, the pozzolanic material is selected from fly ash, silica fume, metakaolin, and ground granulated blast furnace slag. The skilled person will be aware of other pozzolanic materials which are suitable for use with the present composition. In at least one embodiment, the pozzolanic material aids in creating a cement-like material, for uses including but not limited to zonal isolation or containment on the back end of the wellbore.

In at least one embodiment, the composition further contains one or more lost circulation materials, including but not limited to silica, rubber crumbs, insoluble fibers and cellophane flakes. The composition containing such lost circulation materials is useful in controlling circulation loss, and is useful for injection into lost circulation zones, where it can harden, plugging pores in the formation and preventing further loss of well treatment fluids from the zone.

In at least one embodiment, the components of the present aqueous composition are mixed on the surface prior to injection into the formation, as will be well understood by those skilled in the art. In at least one embodiment, when the hardener contains about 30% to about 60% by weight of ethoxylated isodecyl alcohol; about 30% to about 60% by weight of dimethyl 2-methylglutarate; about 5% to about 10% by weight of at least one ethoxyl propoxyl terpene, no more than 5% by weight of polyethylene glycol; and from about 12% to about 20% water by volume, the hardener has a reduced freeze point compared to the hardener containing about 30% to about 60% by weight of ethoxylated isodecyl alcohol; about 30% to about 60% by weight of dimethyl 2-methylglutarate; about 5% to about 10% by weight of at least one ethoxyl propoxyl terpene; no more than 5% by weight of polyethylene glycol; and no more than 1% water by volume. In at least one embodiment, when the hardener contains about 12% water by volume, the freeze point of the hardener is reduced to less than −20° C. or to less than −30° C. Reducing the freeze point of the hardener facilitates the addition of the hardener to the other components on-site during conditions when the ambient temperature is at or below 0° C., since the hardener can remain fluid under such conditions.

### EXAMPLES

Other features of the present invention will become apparent from the following non-limiting examples which illustrate, by way of example, the principles of the invention.

### Compressive Strength

The compressive strength of an embodiment of the present aqueous composition (2 inch cubes cured at 30° C. for 48 hours, at a density of 1500 kg/m³, using Class F flyash) was measured to be 80 psi, using a standard API RP Spec 10 procedure.

### Core Flow Test

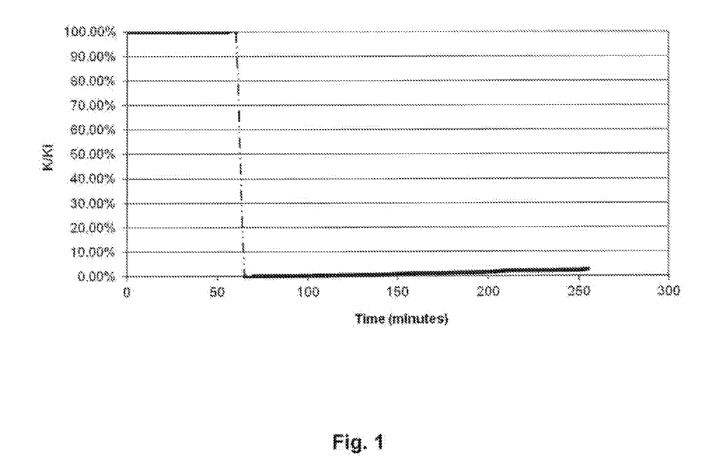

A core flow test of an embodiment of the present aqueous composition (the test aqueous composition) was carried out using a Berea sandstone core sample and the parameters listed in Table 1. The permeability to N₂ is measured at ambient conditions, and the core is evacuated and pressure saturated so that the pore volume can be calculated. The brine (2% aqueous KCl) permeability is measured under the test conditions, and the specified volume of the present aqueous composition is co-injected with brine at an initial flow rate of 100 cm³/h for each fluid. As the pressure increases to 1800 psig, the flow rate is dropped to 50 cm³/h for each fluid, then dropped again to 25 cm³/h for each fluid as the pressure increases to 1950 psig. When the pressure reaches 2000 psig, the pump is stopped, the pressure is allowed to drop to pore pressure, and the system is shut in for 16 to 20 hours. The heads are purged and the regain brine permeability is measured. A graph of permeability (K/Kᵢ)v. time is shown in FIG. 1.

TABLE 1
SAMPLE PARAMETERS

| | |
|---|---|
| Core ID | Berea Test #4 - Coinjection |
| Porosity | 0.175 |
| Routine Permeability | 132.91 mD |
| Length | 7.647 cm |
| Diameter | 2.511 cm |
| Calculated Pore Volume | 6.63 cm³ |

TEST PARAMETERS

| | |
|---|---|
| Fluid to be tested: | Test aqueous composition |
| Base Permeability Fluid: | 2% KCl |
| Initial Water Saturation | 100% |
| Shut In Time | 16-20 Hours |
| Number of pore volumes to be injected: | 3-5 |
| Reservoir Temperature | 30° C. |
| Reservoir Pressure | 500 psig |
| Depth | 1000 m |
| Type of core | Sandstone |
| Overburden Pressure | 1863 psig |

PORE VOLUME MEASUREMENT

| | |
|---|---|
| Start Volume | 433.93 cm³ |
| End Volume | 426.13 cm³ |
| Dead Volume | 1.164973723 cm³ |
| Measured Pore Volume | 6.635026277 cm³ |

PERMEABILITY MEASUREMENT

| | |
|---|---|
| Measured Air Permeability | 132.91 mD |
| Initial Permeability To 2% KCl | 50.28 mD |
| Volume of test aqueous composition to be | 33.18 cm³ |
| injected | |
| Actual Volume of test aqueous composition | 47.00 cm³ |
| injected | |
| Actual Pore Volumes of test aqueous | 7.08 |
| composition injected | |
| Actual Time Shut in | Day 1 4:00 PM |
| Actual Time Regains Started | Day 2 9:30 AM |
| Regain Permeability To 2% KCl | 1.11 mD |
| Reduction in Permeability | 97.79% |

The results show that the permeability of the sample is reduced significantly within about an hour of injection of an embodiment of the present aqueous composition.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

What is claimed is:

1. An aqueous composition for reducing the permeability of a subterranean formation by formation of a silica gel; the composition comprising:
an alkali metal silicate;
a hardener comprising at least one dibasic ester, at least one non-ionic surfactant, at least one terpene or terpene derivative and optionally at least one polyalkylene glycol;
a retarder; and
water.

2. The composition according to claim 1 comprising about 25% to about 60% by volume of the alkali metal silicate; about 5% to about 15% by volume of the hardener; about 0.1% to about 1.5% by volume of the retarder; and about 25% to about 60% water by volume.

3. The composition according to claim 1 wherein the alkali metal silicate is sodium silicate.

4. The composition according to claim 1 wherein the at least one dibasic ester is selected from a di(C₁₋₆)alkyl ethylsuccinate, a di(C₁₋₆)alkyl methylglutarate, a di(C₁₋₆)alkyl adipate, and a mixture thereof.

5. The composition according to claim 4 wherein the at least one dibasic ester is dimethyl 2-methylglutarate.

6. The composition according to claim 1 wherein the at least one non-ionic surfactant is at least one aliphatic alkoxylated alcohol.

7. The composition according to claim 6 wherein the at least one aliphatic alkoxylated alcohol is ethoxylated isodecyl alcohol having a Hydrophile-Lipophile Balance (HLB) number between about 7 and about 15.

8. The composition according to claim 1 wherein the at least one terpene or terpene derivative is selected from pinene and limonene.

9. The composition according to claim 1 wherein the at least one terpene or terpene derivative is an ethoxyl propoxyl terpene.

10. The composition according to claim 1 wherein the at least one polyalkylene glycol is polyethylene glycol.

11. The composition according to claim 1 wherein the hardener comprises about 30% to about 60% by weight of an aliphatic ethoxylated alcohol; about 30% to about 60% by weight of dimethyl 2-methylglutarate; about 5% to about 10% by weight of an ethoxyl propoxyl terpene; and no more than 5% by weight polyethylene glycol.

12. The composition according to claim 1 wherein the retarder is selected from borax, boric acid, alkaline earth metal hydroxides and alkaline earth metal carbonates.

13. The composition according to claim 1 further comprising a pozzolanic material.

14. The composition according to claim 13 wherein the pozzolanic material is selected from fly ash, silica fume, metakaolin, and ground granulated blast furnace slag.

15. The composition according to claim 1 further comprising a lost circulation material.

16. The composition according to claim 15 wherein the lost circulation material is selected from silica, rubber crumbs, insoluble fibers and cellophane flakes.

17. A method of reducing or preventing water flow in a subterranean formation, comprising injecting a composition according to claim 1 into the matrix of the subterranean formation.

18. A method of reducing or preventing lost circulation in a subterranean formation, comprising injecting a composition according to claim 1 into the matrix of the subterranean formation.

19. The method according to claim 17 wherein the subterranean formation is a hydrocarbon-producing formation.

20. The method according to claim 18 wherein the subterranean formation is a hydrocarbon-producing formation.
